(19) United States
(12) Patent Application Publication
(10) Pub. No.: US 2013/0334810 A1
(43) Pub. Date: Dec. 19, 2013

(54) Convolute Tube With Integrated Preformed Angle Fitting

(71) Applicant: Lynwood Crary, Preston, CT (US)

(72) Inventor: Lynwood Crary, Preston, CT (US)

(73) Assignee: TI Group Automotive Systems, LLC, Auburn Hills, MI (US)

(21) Appl. No.: 13/526,063

(22) Filed: Jun. 18, 2012

(51) Int. Cl. F16L 21/00

(52) U.S. Cl. 285/31

(57) ABSTRACT

A connector assembly for a fluid system comprising a flexible tube with a series of convolutions integrated with a connector having tubular portions disposed at a sharp angle to each other. In one form, the connector and flexible hose are made from the same material, nylon-12 and are spin welded together.

This disclosure relates to a fluid line for fuel pump modules for vehicular fuel systems. More particularly, it relates to a fuel module fuel line having an integral, convolute tube and a steep angled connection element.

Fuel Modules are an important part of modern vehicular fuel systems. Examples may be found in U.S. Pat. Nos. 5,642,718; 5,785,032; 6,045,685; 7,140,247; 7,527,042 and others.

Flexible convolute hoses are often used to transfer fuel and vapor in automotive fuel delivery systems. The flexibility allows for relative motion between components and also reduces transmitted noise and vibration. The typical convolute tube has a straight cuff section at each end, and the modulus of the convolute material is sufficient that the cuff is typically pressed over a slightly oversized rigid barbed fitting to create a liquid/vapor seal. The manufacturing process used to produce the convolute tube requires that the end cuff section be straight because the tubes are molded in a continuous chain and then sectioned into length.

There may be applications where it is desirable to attach the convolute tube directly to another flexible component, such as an elbow fitting, tee fitting, bulkhead fitting, or manifold. In such case, the flexible component is not rigid enough to create a sufficient seal with a barbed fitting—the barbs would be too soft and deform. Therefore, attaching such a component to a flexible hose would normally require a rigid barbed coupling with barbs on both ends—one end is pressed into the component, and the other into the flexible convolute hose.

To avoid the expense, leak risk, and extra length required by such a rigid coupling, in this disclosure the flexible component is produced from a material with a similar modulus to that of the convolute (preferably the same material as the convolute), and the component and the convolute are connected together by spin welding according to the same methods that are used to attach fuel lines to their associated end connectors. This creates an inexpensive, leakproof, compact joint.

As an example of this application, consider a typical in-tank automotive electric fuel pump that is cylindrical in shape, with the pump inlet on the bottom end and the outlet port on the top end. The outlet port fitting is usually oriented axially to the pump body. An angled outlet fitting could be used but is more difficult to mold, and since it would have to protrude past the outer diameter of the pump shell it could cause assembly issues for both the pump itself and later for installing the pump into the fuel delivery module. A barbed fitting on the pump outlet is the preferred connection method between the pump and the convolute outlet hose. When this convolute hose is connected to the outlet of the pump it is usually necessary to loop the tube one hundred eighty degrees (180°) back down towards the bottom of the pump/module in order to connect to the fuel delivery module final filter. This required loop takes at least 50 millimeters (mm) of height to prevent kinking. In applications where a low module height is required, many times the space required for the convolute prevents the module conforming to the required height, forcing other design changes. It would be advantageous to use a convolute with an angled fitting (“elbow”) instead of the straight cuff to eliminate the need for the tall loop.

Since, as stated earlier, it is not possible to directly produce a convolute hose with a molded elbow, the arrangement presented in this disclosure as a solution comprises a flexible injection molded elbow fitting attached to the straight cuff on the end of the flexible convolute hose by spin welding. The elbow may then be pressed over the rigid barb fitting on the pump outlet and the other end of the convolute hose connected to the inlet of the filter body. This application is, of course, only exemplary and the conduit created is suitable for other applications.

On the certain fuel module designs, a low-height connection is needed from the pump outlet to the filter inlet to reduce the module installed height as much as possible. Numerous approaches were considered possible. For example, a unitary convolute tube with a preformed angle fitting on one end would be preferred, but such a feature is not possible with the extrusion/blow mold process used to make convolutes. Also a two-piece design could be employed. But, it adds cost and could create an assembly issue maintaining the orientation of ports which the two halves are assembled. A two piece design does not offer sufficient part flexibility to allow the connection to be made at the filter pack once the pump is in place. Completing the connection concurrently with installing the pump into its retainer could lead to assembly alignment issues.

Flexible molded nylon fittings were considered in a prototype module design. The fitting was flexible enough to allow installation over a triple barb fitting and the nylon material used was identical to that in convolutes. But to attach to a standard convolute, this flexible fitting would have to have a male barb feature on one end. This end of the fitting would have to be rigid enough to maintain the size and shape of the barbs. It was concluded that it is not possible to mold a fitting that is flexible enough on one end to allow installation over a triple barb, yet rigid enough on the other end to act as a triple barb without overmolding two materials.

The present disclosure is directed to a design that would mate a convolute hose to a flexible angled fitting. The angle of the fitting could be changed for use on other applications (supply convolute to flange, for example). The connection is accomplished by spin welding. The resultant component is particularly suitable for fuel module applications.

### DESCRIPTION OF THE DRAWINGS

FIG. 1 is a side view, in section of a typical known vehicular fuel pump module commonly used in vehicular fuel systems.

FIG. 2 is a perspective view of the convolute tube and integrated pre-formed angle end fitting or connector of the present disclosure.

FIG. 3 is a side sectional view of the pre-formed angle end fitting or connector of FIG. 2.

FIG. 4 is a side sectional view of the convolute tube and angle end fitting of the assembly of FIG. 2.

### DETAILED DESCRIPTION

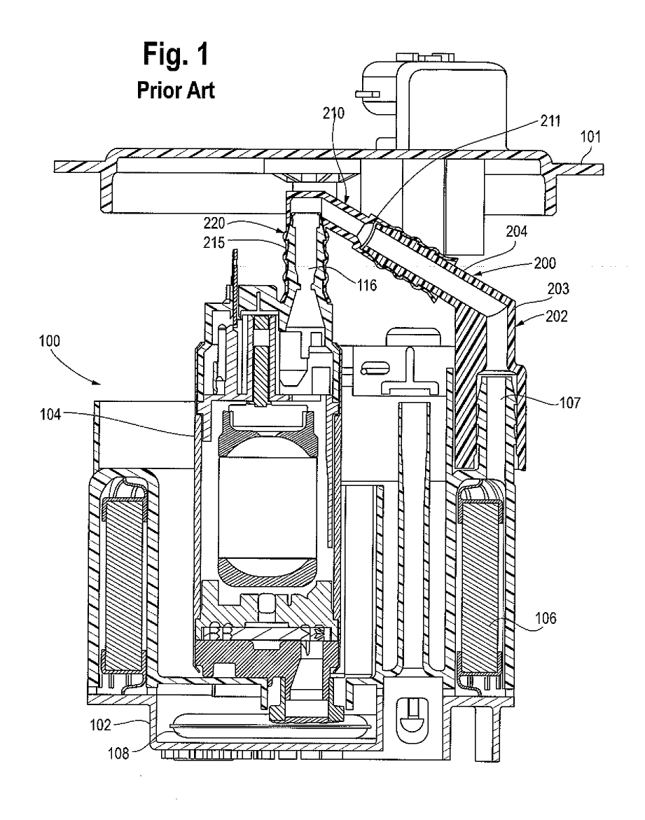

Turning now to the drawings, FIG. 1 illustrates a known fuel module assembly generally designated 100. It is exemplary of an application successfully served by the connector and tube of the present disclosure. It is positioned in a vehicular fuel tank for delivery of fuel from the tank to the vehicle fuel system.

Module assembly 100 includes a tank flange 101 for securement to a fuel tank. A reservoir 102, a pump 104, and filter housing 106 depend from the tank flange, and are vertically adjustable relative to the tank flange 101 to accommodate various tank height dimensions.

Pump 104 includes a screened inlet 108 positioned at the bottom of the fuel reservoir 102. It includes a pump discharge 110 defined by a barbed tube end.

Filter housing 106 includes an inlet 107 that receives fuel from the pump discharge 110. It is also defined by a barbed tube end.

A fuel passage defined by a conduit 200 extends from the discharge 110 of the pump 104 to the inlet 107 of the fuel filter housing 106. Due to space requirements within the module, this component is formed of two separate elements joined together to make connections possible. The two piece connection includes a hollow rigid body 202 that connects in fluid tight relation to the filter housing inlet 107. Body 202 includes a vertical portion 203 and an angled tube 204 that extends toward the pump discharge 110 which is more central to the module, and vertically higher than the inlet 107 to filter housing 106.

A molded connector 210 of flexible plastic includes a tubular body portion 211 with a flexible connection end portion extending from one end connected to angled tube 204. A second connection portion 215 is secured in fluid tight relation to the pump discharge 110. In this illustration, the angle between the portions of the connector is about forty-five degrees (45°), though any suitable angle is contemplated.

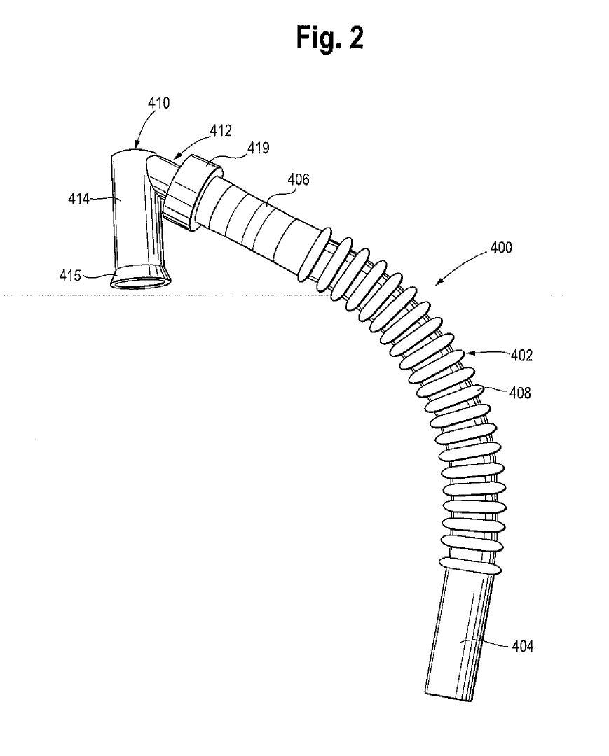

Turning now to FIGS. 2, 3 and 4, there is disclosed a connector assembly 400 of the present disclosure to provide a fluid path between the discharge 110 of pump 104 and the inlet 107 to filter housing 106. It satisfies the need for a low profile connector between the pump and filter housing that meets the criteria of inherent space constraints within the fuel module 100 and is efficiently produced and installed. It is also a reliable and desirable connection.

While the connection conduit 400 of the present disclosure is disclosed in the context of its suitability for the pump module 100 illustrated in FIG. 1, this application is merely illustrative. The connection conduit of the present disclosure is suitable for applications in any fuel module arrangement that requires an effective and secure fluid path while also presenting the unique constraints of space and height limitations included here.

The connector assembly 400 includes a convolute hollow tube 402 and a separate molded hollow connector 410. They are unitized to form a single conduit component.

Convolute tube 402 includes an end 404 sized to engage the inlet tube 107 of filter housing 106 in fluid tight relation. In this regard, it is sufficiently flexible to receive the barbed exterior of the inlet tube 107 of the filter housing 106. Its opposite end 406 is cylindrical and sized to be affixed to connector 410.

Tube 402 is molded to include a series of convolutions 408 to render the tube flexible and suitable for necessary deformation or bending during assembly of the fuel module 100. It may be molded of PBC-130 or nylon-12.

Connector 410 is molded of plastic, which could be nylon 12 for example. It includes a first tubular portion 412 sized to connect to end 406 of convolute tube 402 in a manner hereinafter described.

Connector 410 includes a second tubular portion 414 molded integrally with the first tubular potion but at a sharp angle relative to the longitudinal axis of the first portion. In the form illustrated, the angle is about forty-five degrees (45°) though any desired angular relation is contemplated.

Second tubular portion 414 is sized to connect to the pump discharge tube 110 in fluid tight relation. That is, it has an inner diameter that is sufficiently smaller than the outer diameter of pump discharge tube 110 to create a fluid tight seal when inserted upon discharge tube 110. In this regard it is sufficiently flexible to receive the barbed exterior of the discharge tube 110 of pump 104. It includes a diverging flange portion 415 at its end to guide installation onto the discharge tube 110.

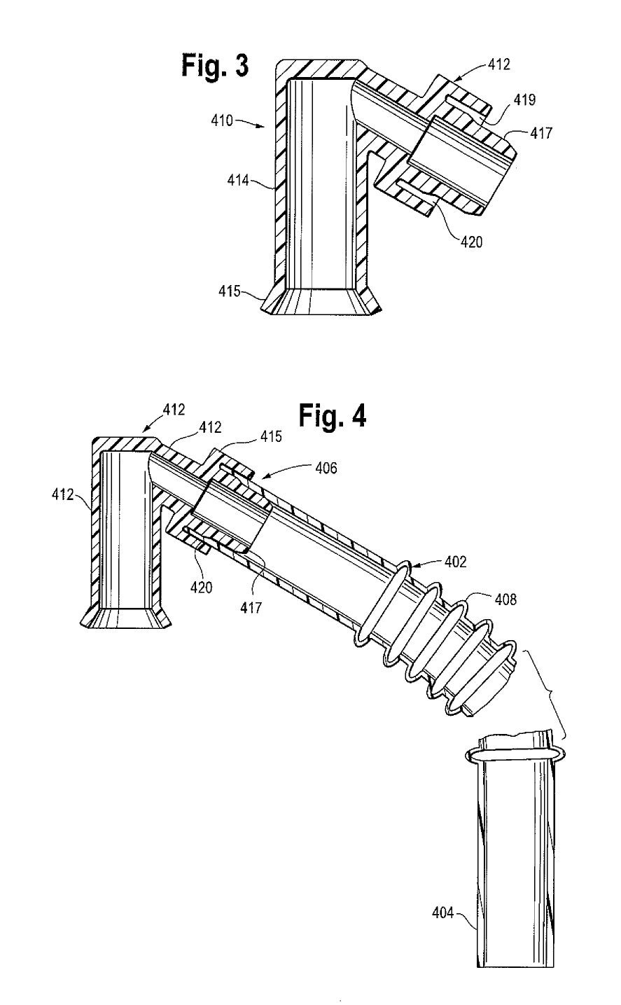

Referring to FIG. 3, the end 412 is configured to provide for a fluid tight connection to the end 406 of convolute tube 402 by the spin welding process. It includes a central core portion 417 sized to fit within the bore defined by end 406 of convolute tube 402 in a slight interference fit. That is, the outer diameter of core portion 417 is slightly larger than the inner diameter of end 406 of tube 402.

End 406 further includes a connected axially extending flange ring 419 coaxial with core portion that defines an open ended groove 420. The core portion 417 and connected flange ring 419 are sized to receive the end 406 of convolute tube 402 so as to create a fluid tight joint by spin welding.

Such a joint is well known and disclosed, for example, in U.S. Pat. Nos. 6,832,785; 6,199,916 and others. The particular details of such joint formation are not a part of this disclosure and may be made using any suitable prior art process.

The connector assembly 400 of the present disclosure provides a unitized connection conduit for fluid tight connection between various fluid handling components of a fluid system, such as a vehicular fuel system. It provides a flexible connector assembly to connect between components reliably and with ease. The material of the convolute tube and connector must be sufficiently flexible to permit bending of the convolute portion of the tube and sufficiently rigid to permit insertion of a rigid barb into the tubular portion 414.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

1. A fluid connection assembly for connection between components in a fluid system comprising:
a hollow flexible fluid tube having an inner bore and including a portion having a series of convolutions between end portions;
a hollow connector defining a fluid path between ends;
an end of said connector defined by a flange comprising an outer flange ring
and a core portion, said core portion disposed within the inner bore of said tube,
said flange ring surrounding the outer surface of said tube end portion;
said tube end portion and said flange are joined in fluid tight relation.

2. A fluid connection assembly as claimed in claim 1 wherein said connector has a first tubular portion and a second tubular portion and defines a fluid path between its ends.

3. A fluid connection assembly as claimed in claim 2 wherein said fluid paths are at an angle to each other.

4. A fluid connection assembly as claimed in claim 3 wherein said angle is approximately forty-five degrees (45°).

5. A fluid connection assembly as claimed in claim 1 wherein said flexible fluid tube and said connector are made of flexible polymeric material.

6. A fluid connection assembly as claimed in claim 5 wherein said material is nylon-12.

7. A fluid connection assembly as claimed in claim 2 wherein said flexible fluid tube and said connector are made of flexible polymeric material.

8. A fluid connection assembly as claimed in claim 7 wherein said material is nylon-12.

9. A fluid connection assembly as claimed in claim 3 wherein said flexible fluid tube and said connector are made of flexible polymeric material.

10. A fluid connection assembly as claimed in claim 9 wherein said material is nylon-12.

11. A fluid connection assembly as claimed in claim 4 wherein said flexible fluid tube and said connector are made of flexible polymeric material.

12. A fluid connection assembly as claimed in claim 11 wherein said material is nylon-12.

13. A fluid connection assembly as claimed in claim 5 wherein said tube end portion and said flange are welded together by spin welding.

14. A fluid connection assembly as claimed in claim 6 wherein said tube end portion and said flange are welded together by spin welding.

15. A fluid connection assembly as claimed in claim 7 wherein said tube end portion and said flange are welded together by spin welding.

16. A fluid connection assembly as claimed in claim 8 wherein said tube end portion and said flange are welded together by spin welding.

17. A fluid connection assembly as claimed in claim 9 wherein said tube end portion and said flange are welded together by spin welding.

18. A fluid connection assembly as claimed in claim 10 wherein said tube end portion and said flange are welded together by spin welding.

19. A fluid connection assembly as claimed in claim 11 wherein said tube end portion and said flange are welded together by spin welding.

20. A fluid connection assembly as claimed in claim 12 wherein said tube end portion and said flange are welded together by spin welding.
